(19) United States
(12) Patent Application Publication
(10) Pub. No.: US 2025/0126210 A1
(43) Pub. Date: Apr. 17, 2025

(54) VOICE CALL MANAGEMENT METHOD AND APPARATUS THEREOF

(71) Applicant: MEDIATEK INC., Hsinchu City (TW)

(72) Inventors: Hao-Cheng WANG, Hsinchu City (TW); Kuan-Ming LIN, Hsinchu City (TW); Nuan-Yu YANG, Hsinchu City (TW); Chien-Yi WANG, Hsinchu City (TW)

(21) Appl. No.: 18/910,553

(22) Filed: Oct. 9, 2024

Related U.S. Application Data
(60) Provisional application No. 63/589,652, filed on Oct. 12, 2023.

(51) Int. Cl. H04M 7/00

(52) U.S. Cl. CPC H04M 7/0006

(57) ABSTRACT

A voice call management method is provided. The voice call management method may be applied to an apparatus. The voice call management method may include the following steps. The apparatus may determine the current scenario associated with the operation environment of the apparatus. Then, the apparatus may determine to perform a voice call through a modem (MD) voice engine or through an application processor (AP) voice engine according to the current scenario.

### CROSS REFERENCE TO RELATED APPLICATIONS

This application claims the benefits of U.S. Provisional Application No. 63/589,652 filed on Oct. 12, 2023, the entirety of which is incorporated by reference herein.

### BACKGROUND OF THE INVENTION

### Field of the Invention

The invention generally relates to voice call management technology, and more particularly, to voice call management under different scenarios.

### Description of the Related Art

Unless otherwise indicated herein, approaches described in this section are not prior art to the claims listed below and are not admitted as prior art by inclusion in this section.

In a conventional transmission technologies for a voice call (e.g., a voice over LTE (VOLTE) call, a voice over NR (VoNR) call, or a voice over Wi-Fi (VoWiFi) call), the user equipment (UE) may select a modem (MD) voice engine (or MD audio real-time transport protocol (RTP) engine) for a VOLTE call or a VoNR call, or it may select an application processor (AP) voice engine (or AP audio RTP engine) for a VoWiFi call. However, when the UE performs a handover between a VOLTE call (or VoNR call) and a VoWiFi call, the UE may need to transfer the internet protocol (IP) multimedia subsystem (IMS) call context and switch the RTP connection between AP and MD. As a result, there may be handover latency, and the call quality may be affected by this handover latency.

Therefore, how to manage a voice call to reduce handover latency is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to a voice call management with respect to user equipment (UE) and network apparatus in mobile communications. It is believed that the above-described issue would be avoided or otherwise alleviated by implementing one or more of the proposed schemes described herein.

An embodiment of the invention provides a voice call management method. The voice call management method may be applied to an apparatus. The voice call management method may include the following steps. The apparatus may determine the current scenario associated with the operation environment of the apparatus. Then, the apparatus may determine to perform a voice call through a modem (MD) voice engine or through an application processor (AP) voice engine according to the current scenario.

In some embodiments, the current scenario may comprise at least one of the following scenarios: the apparatus currently only supports a Wi-Fi service, the apparatus currently only supports a cellular network service, and the apparatus supports the Wi-Fi service and the cellular network service at the same time.

In some embodiments, the apparatus may disable the AP voice engine in the event that the apparatus currently only supports the cellular network service.

In some embodiments, the apparatus may disable the processor, the MD voice engine in the event that the apparatus currently only supports the Wi-Fi service.

In some embodiments, the apparatus may disable the AP voice engine in the event that the apparatus supports the Wi-Fi service and the cellular network service at the same time.

An embodiment of the invention provides an apparatus. The apparatus may include a transceiver and a processor. The transceiver may be configured to perform wireless transmission and reception to and from a network node. The processor may be coupled to the transceiver. The processor may perform the following operations. The operations may comprise determining the current scenario associated with the operation environment of the apparatus. The operations may also comprise determining to perform a voice call through an MD voice engine or through an AP voice engine according to the current scenario.

Other aspects and features of the invention will become apparent to those with ordinary skill in the art upon review of the following descriptions of specific embodiments of the voice call management method and the apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus 200 according to an embodiment of the application.

FIG. 3 is a block diagram illustrating a network node 300 according to an embodiment of the application.

FIG. 4A is a schematic diagram illustrating a VoWiFi call data transmission according to an embodiment of the invention.

FIG. 4B is a schematic diagram illustrating a VoWiFi call data transmission according to another embodiment of the invention.

FIG. 5 is a flow chart illustrating a voice call management method 500 according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

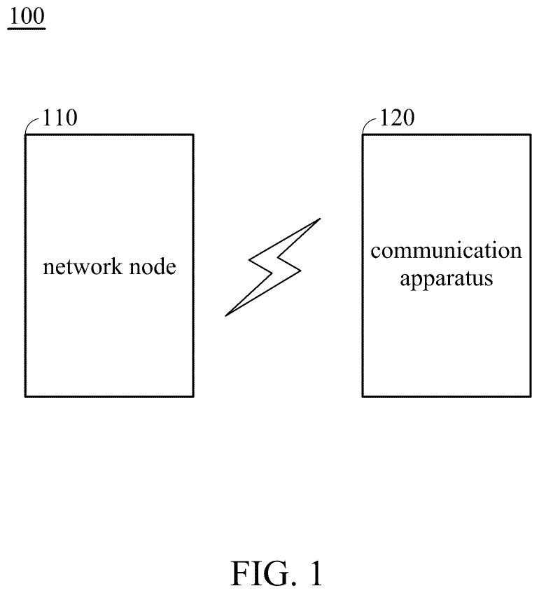

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point (AP), an access terminal, a Wi-Fi hotpot, but the invention should not be limited thereto. In an embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto. In another embodiment, the communication apparatus 120 may be in wireless communication with a wireless network including a non-terrestrial network (NTN) and a TN via the network node 110. That is, the network node 110 may be a terrestrial network node (e.g., an eNB, a gNB, or a transmission/reception point (TRP)) and/or a non-terrestrial network node (e.g., a satellite). For example, the terrestrial network node and/or the non-terrestrial network node may form an NTN serving cell for wireless communication with the communication apparatus 120. In another embodiment, the network node 110 may be an entity compatible with the Institute of Electrical and Electronics Engineers (IEEE) 802.11 standards to provide and manage the access to the wireless medium for the communication apparatus 120.

In the embodiments of the invention, the communication apparatus 120 may be a user equipment (UE), a non-AP station (STA), a smartphone, Personal Data Assistant (PDA), pager, laptop computer, desktop computer, wireless handset, or any computing device that includes a wireless communications interface. In addition, the communication apparatus 120 may be an entity compatible with the Institute of Electrical and Electronics Engineers (IEEE) 802.11 standards.

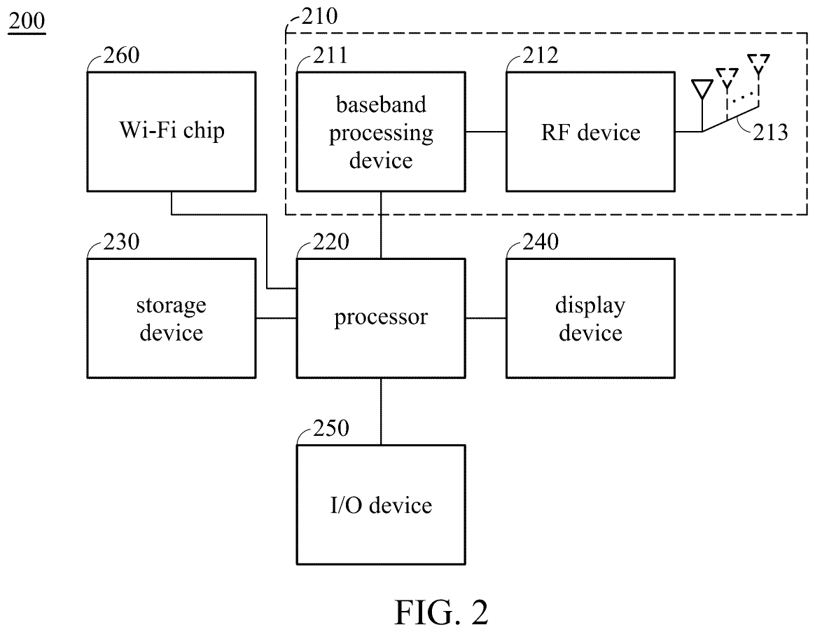

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may comprise Wi-Fi antenna and may be configured to perform the operations of Wi-Fi communications.

According to an embodiment of the invention, the wireless transceiver 210 may be configured in a modem (MD) of the communication apparatus 200, and the processor 220 may be configured in an application processor (AP) of the communication apparatus 200. The MD may comprise an audio real-time transport protocol (RTP) engine or a voice engine for internet protocol (IP) multimedia subsystem (IMS) call (e.g., a voice over LTE (VOLTE) call, a voice over NR (VoNR) call, and a voice over Wi-Fi (VoWiFi) call). The AP may also comprise an audio RTP engine or a voice engine for a VoWiFi call. In another example, the processor 220 may be configured in the MD of the communication apparatus 200, e.g., the processor 220 is an MCU.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

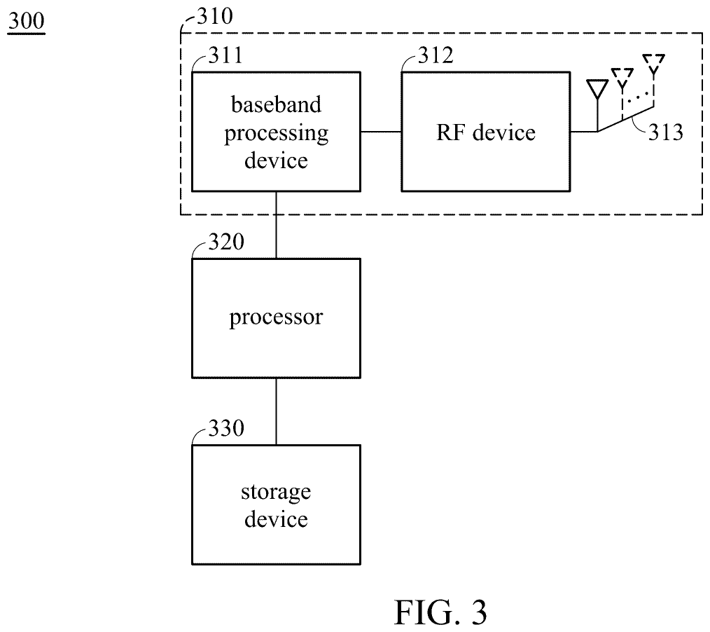

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPU/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, when an apparatus (e.g., communication apparatus 120) needs to perform a voice call, the apparatus may determine the current scenario that is associated with the operation environment of the apparatus. Then, the apparatus may determine to perform the voice call through an MD voice engine or through an AP voice engine according to the current scenario.

According to an embodiment, the current scenario may comprise at least one of the following scenarios: the apparatus currently only supports a Wi-Fi service (i.e., the apparatus may currently only be able to perform the VoWiFi call); the apparatus currently only supports a cellular network service (i.e., the apparatus may currently only be able to perform the VOLTE call or VoNR call); and the apparatus supports the Wi-Fi service and the cellular network service at the same time (i.e., the apparatus may currently perform the VOLTE call, the VoNR call, and the VoWiFi call), but the invention should not be limited thereto.

According to an embodiment of the invention, when the current scenario is that the apparatus currently only supports the cellular network service (e.g., there is no Wi-Fi connection or the apparatus may be a car system or an internet-of-things (IoT) device without Wi-Fi component, but the invention should not be limited thereto), the apparatus may currently only be able to perform the VOLTE call or VoNR call. Therefore, the apparatus may disable the AP voice engine (or the AP audio RTP engine) and the Wi-Fi related function to save power.

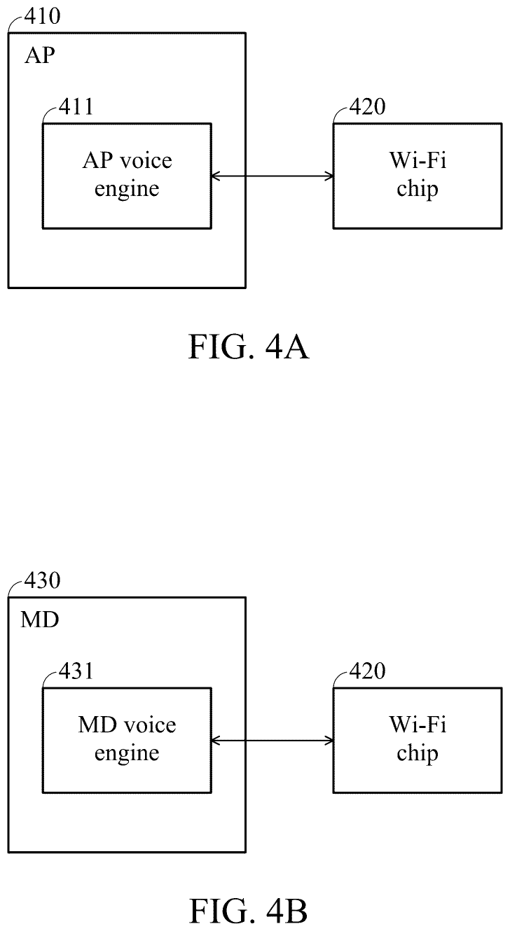

According to an embodiment of the invention, when the current scenario is that the apparatus currently only supports the Wi-Fi service (e.g., the apparatus is in an airplane mode, or the apparatus is in a Wi-Fi only environment, but the invention should not be limited thereto), the apparatus may currently only be able to perform the VoWiFi call. Therefore, the apparatus may disable the MD voice engine (or MD audio RTP engine) and the RF function to save power. FIG. 4A is a schematic diagram illustrating a VoWiFi call data transmission according to an embodiment of the invention. A shown in FIG. 4A, when the apparatus perform the VoWiFi call through the AP voice engine 411 of the AP 410 of the apparatus, the AP voice engine 411 may transmit the VoWiFi call data to the Wi-Fi chip 420 of the apparatus, and receive the VoWiFi call data from the Wi-Fi chip 420.

According to an embodiment of the invention, when the current scenario is that the apparatus can support the Wi-Fi service and the cellular network service at the same time, the apparatus currently may be able to perform the VOLTE call, the VoNR call, and the VoWiFi call. In the embodiment, the apparatus may use (or select) the MD voice engine (or MD audio RTP engine) for voice call, and disable the AP voice engine (or the AP audio RTP engine) to reduce the handover latency between the VOLTE call (or the VoNR call) and the VoWiFi call and reduce power consumption. Specifically, in the embodiment, when the apparatus determine to handover the voice call from the VOLTE call (or the VoNR call) to the VoWiFi call, the apparatus may perform the VoWiFi call through the MD voice engine without switching to the AP voice engine. Therefore, the handover latency between the VOLTE call (or the VoNR call) and the VoWiFi call can be reduced. FIG. 4B is a schematic diagram illustrating a VoWiFi call data transmission according to another embodiment of the invention. A shown in FIG. 4B, when the apparatus can support the Wi-Fi service and the cellular network service at the same time, the apparatus may perform the VoWiFi call through the MD voice engine 431 of the MD 430 of the apparatus. That is, in the embodiment, the MD voice engine 431 may transmit the VoWiFi call data to the Wi-Fi chip 420 of the apparatus, and receive the VoWiFi call data from the Wi-Fi chip 420.

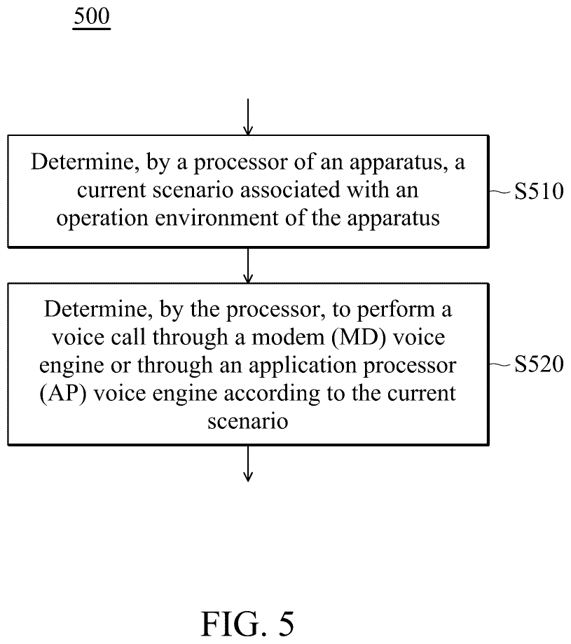

FIG. 5 is a flow chart illustrating a voice call management method 500 according to an embodiment of the invention. The voice call management method can be applied to the wireless communication system 100. As shown in FIG. 5, in step S510, an apparatus (e.g., the communication apparatus 120 of wireless communication system 100) may determine the current scenario associated with the operation environment of the apparatus.

In step S520, the apparatus may determine to perform a voice call through a modem (MD) voice engine or through an application processor (AP) voice engine according to the current scenario.

According to an embodiment of the invention, in the voice call management method, the current scenario may comprise at least one of the following scenarios: the apparatus currently only supports a Wi-Fi service; the apparatus currently only supports a cellular network service; and the apparatus supports the Wi-Fi service and the cellular network service at the same time.

According to an embodiment of the invention, in the voice call management method, the apparatus may disable the AP voice engine in the event that the apparatus currently only supports the cellular network service.

According to an embodiment of the invention, in the voice call management method, the apparatus may disable the MD voice engine in the event that the apparatus currently only supports the Wi-Fi service.

According to an embodiment of the invention, in the voice call management method, the apparatus may disable the AP voice engine in the event that the apparatus supports the Wi-Fi service and the cellular network service at the same time.

According to the voice call management method provided in the invention, the apparatus can perform the voice call according to different scenarios to reduce power consumption and reduce the handover latency.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A voice call management method, comprising:
determining, by a processor of an apparatus, a current scenario associated with an operation environment of the apparatus; and
determining, by the processor, to perform a voice call through a modem (MD) voice engine or through an application processor (AP) voice engine according to the current scenario.

2. The voice call management method of claim 1, wherein the current scenario comprises at least one of following scenarios: the apparatus currently only supports a Wi-Fi service; the apparatus currently only supports a cellular network service; and the apparatus supports the Wi-Fi service and the cellular network service at the same time.

3. The voice call management method of claim 2, further comprising:
disabling, by the processor, the AP voice engine in an event that the apparatus currently only supports the cellular network service.

4. The voice call management method of claim 2, further comprising:
disabling, by the processor, the MD voice engine in an event that the apparatus currently only supports the Wi-Fi service.

5. The voice call management method of claim 2, further comprising:
disabling, by the processor, the AP voice engine in an event that the apparatus supports the Wi-Fi service and the cellular network service at the same time.

6. An apparatus, comprising:
a transceiver, configured to perform wireless transmission and reception to and from a network node; and
a processor, coupled to the transceiver, and performing operations comprising:
determining a current scenario associated with an operation environment of the apparatus; and
determining to perform a voice call through a modem (MD) voice engine or through an application processor (AP) voice engine according to the current scenario.

7. The apparatus of claim 6, wherein the current scenario comprises at least one of following scenarios: the apparatus currently only supports a Wi-Fi service; the apparatus currently only supports a cellular network service; and the apparatus supports the Wi-Fi service and the cellular network service at the same time.

8. The apparatus of claim 6, wherein the processor performs operations comprising:
disabling the AP voice engine in an event that the apparatus currently only supports the cellular network service.

9. The apparatus of claim 6, wherein the processor performs operations comprising:
disabling the MD voice engine in an event that the apparatus currently only supports the Wi-Fi service.

10. The apparatus of claim 6, wherein the processor performs operations comprising:
disabling the AP voice engine in an event that the apparatus supports the Wi-Fi service and the cellular network service at the same time.
